(19) United States
(12) Patent Application Publication
(10) Pub. No.: US 2026/0132810 A1
(43) Pub. Date: May 14, 2026

(54) SCREW STRUCTURE AND CONNECTOR

(71) Applicant: BIZLINK INTERNATIONAL CORP., New Taipei City (TW)

(72) Inventors: Chao LIAO, New Taipei City (TW); Zengshi LAO, New Taipei City (TW); Haoran ZOU, New Taipei City (TW)

(21) Appl. No.: 19/387,661

(22) Filed: Nov. 13, 2025

(30) Foreign Application Priority Data
Nov. 13, 2024 (CN) 202422772069.8
Jul. 17, 2025 (CN) 202521509412.8

(51) Int. Cl. F16B 39/26

(52) U.S. Cl. CPC F16B 39/26

(57) ABSTRACT

The present disclosure discloses a screw structure and a connector and relates to the technical field, in which the screw structure includes a screw, a first elastic part, and a base. The screw includes a screw head, a screw rod portion, and a thread portion connected in sequence. The first elastic part is disposed around the screw rod portion, and an end of the first elastic part abuts against the screw head. The base has a central hole and the screw rod portion passes through the central hole and abuts against an end of the first elastic part away from the screw head. An inner diameter of the central hole is smaller than an inner diameter of the first elastic part, and the inner diameter of the central hole is smaller than a maximum outer diameter of the thread portion.

### CROSS-REFERENCE TO RELATED APPLICATION

This application claims priority to China Application Serial Number 202521509412.8, filed July 17, 2025 and China Application Serial Number 202422772069.8, filed November 13, 2024, which are herein incorporated by reference in its entirety.

### BACKGROUND

### Field of Invention

The present disclosure relates to a connector technology, and more particularly, to a screw structure and a connector.

### Description of Related Art

In servers, busbars are responsible for the critical task of transferring electrical energy from power modules to high-power core components, such as CPUs and GPUs efficiently and with low loss.

In general application scenarios, screws are usually used to fix busbars to brackets or insulating seats. To ensure the reliability and the vibration resistance during long-term operation, the existing technology usually puts a spring, a circular base, and a disc spring on a screw sequentially, and then passes the screw through a mounting hole of the busbar and screws the screw to the bracket.

However, in the actual assembly process, human errors, such as the disc springs being installed backwards or of the base being omitted, are very likely to occur, such that the possibility of the screw structures loosening during server operation is greatly increased, which reduces the stability of the server operation.

### SUMMARY

One main objective of the present disclosure is to provide a screw structure that can reduce the possibility of the screw structure coming loose during the server operation.

In order to achieve the above objective, a screw structure provided in the present disclosure includes a screw including a screw head, a screw rod portion, and a thread portion connected in sequence; a first elastic part disposed around the screw rod portion and an end of the first elastic part abutting against the screw head; and a base having a central hole, and the screw rod portion passing through the central hole and abutting against an end of the first elastic part away from the screw head. An inner diameter of the central hole is smaller than an inner diameter of the first elastic part, and the inner diameter of the central hole is smaller than a maximum outer diameter of the thread portion.

In one embodiment of the present disclosure, the central hole is formed with a stepped surface facing the screw head, and the end of the elastic part away from the screw head abuts against the stepped surface.

In one embodiment of the present disclosure, the screw rod portion has a protruding ring protruding from an end of the screw rod portion adjacent

to the screw head. An end of the first elastic part away from the thread portion is engaged and sleeved on an outer wall of the protruding ring.

In one embodiment of the present disclosure, the protruding ring includes an inserting section and an engaging section connected to each other. The inserting section is located on an end of the engaging section away from the screw head. The inserting section gradually narrows along a direction from an end of the inserting section adjacent to the screw head to an end of the inserting section away from the screw head.

In one embodiment of the present disclosure, the screw structure further includes a second elastic part. The second elastic part is disposed around the screw rod portion and located between the screw head and the base.

In one embodiment of the present disclosure, the second elastic part has a through hole, and the screw rod portion passes through the through hole. An inner diameter of the through hole is smaller than a maximum outer diameter of the screw head, and a diameter of the second elastic part is greater than the inner diameter of the central hole.

In one embodiment of the present disclosure, the diameter of the second elastic part is smaller than a diameter of the base.

In one embodiment of the present disclosure, the first elastic part is a spring.

In one embodiment of the present disclosure, the second elastic part is a disc spring.

The present disclosure further provides a connector including a busbar and the screw structure. The base is disposed on the busbar, the busbar has a through hole, and the screw rod portion and the thread portion pass through the through hole.

In the technical concept of the present disclosure, the screw structure includes a screw, a first elastic part, and a base. The screw includes a screw head, a screw rod portion, and a thread portion connected in sequence. The first elastic part is disposed around the screw rod portion, and an end of the first elastic part abuts against the screw head. The base has a central hole and the screw rod portion passes through the central hole and abuts against an end of the first elastic part away from the screw head. An inner diameter of the central hole is smaller than an inner diameter of the first elastic part, and the inner diameter of the central hole is smaller than a maximum outer diameter of the thread portion. In the technical concept of the present disclosure, the assembly sequence is forcibly limited by the dimensional fit between the center hole of the base and the first elastic part as well as the thread portion to prevent the base from being omitted or the first elastic part from being misaligned. Meanwhile, the abutting relationship between the first elastic part and the base forms a buffer structure, such that the vibration resistance of the screw structure is increased. By designing the inner diameter of the central hole of the base to be smaller than the inner diameter of the first elastic part and the maximum outer diameter of the thread portion, the self-positioning assembly is achieved and human error is reduced. In applications, such as servers that require highly reliable connections, the screw structure of the present disclosure can efficiently reduce the loosening risk of the connection due to improper assembly, and enhance the stability during long-term operation of apparatuses.

### BRIEF DESCRIPTION OF THE DRAWINGS

In order to more clearly illustrate the technical concepts of the embodiments of the present disclosure or the existing technology, the drawings used in the description of the embodiments or the prior art will be briefly described below. It is apparent that the drawings in the following description are merely some embodiments of the present disclosure, and a person having ordinary skill in the art can obtain other drawings based on the structures illustrated by these drawings without creative efforts.

FIG. 1 is a schematic structural diagram of a screw structure according to an example of the present disclosure.

FIG. 2 is a cross-sectional view taken along A-A in FIG. 1.

FIG. 3 is a schematic structural diagram of a position B in FIG. 2.

FIG. 4 is a schematic structural diagram of an example of a connector provided by the present disclosure.

FIG. 5 is a cross-sectional view taken along C-C in FIG. 4.

FIG. 6 is a cross-sectional view taken along D-D in FIG. 4.

FIG. 7 is a schematic structural diagram of an example of a circlip provided by the present disclosure.

The realization of the purpose, functional features, and advantages of the present disclosure will be further explained in conjunction with embodiments and with reference to the accompanying drawings.

### DETAILED DESCRIPTION

The technical concepts in the embodiments of the present disclosure are clearly and completely described below in conjunction with the accompanying drawings in the embodiments of the present disclosure. Obviously, the described embodiments are merely some embodiments of the present disclosure, rather than all of the embodiments. Based on the embodiments of the present disclosure, all other embodiments obtained by those skilled in the art without creative efforts shall fall within the protection scope of the present disclosure.

It should be noted that if there are directional indications (such as up, down, left, right, front, and back…….) involved in the present disclosure, the direction indications are merely used to explain relative position relationships and motion states between the components in specific postures. If the specific postures change, the direction indications also change correspondingly.

In addition, if there are descriptions related to "first", "second", and the like in the embodiments of the present disclosure, the descriptions of “first”, “second”, and the like are merely used for the descriptive purpose and cannot be understood as indicating or implying their relative importance or implying the quantities of the indicated technical features. Accordingly, the features defined as “first,” “second,” and the like may explicitly or implicitly include at least one feature. Furthermore, the terms “and/or” is presented throughout the specification, it is intended to include three parallel schemes. “A and/or B” is taken as an example, which includes scheme A, scheme B, or a scheme that is satisfied by both A and B. Moreover, the technical concepts of the embodiments can be combined with each another, but need to be implemented by a person having ordinary skill in the art. When there is a conflict in a combination of technical concepts or the combination cannot be achieved, it should be considered that the combination of the technical solutions does not exist and does not within the protection of the present disclosure.

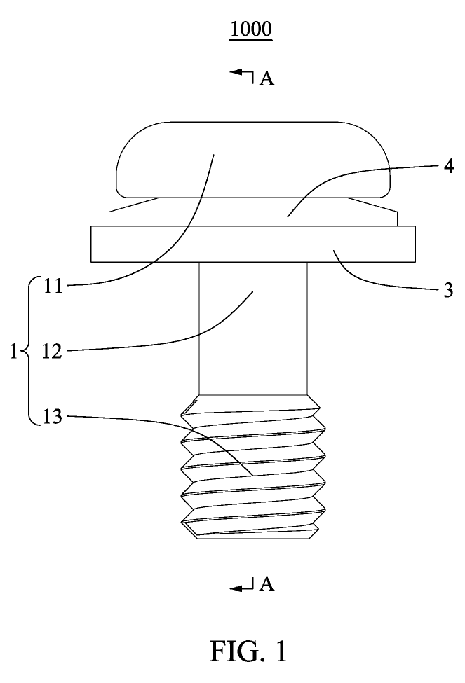

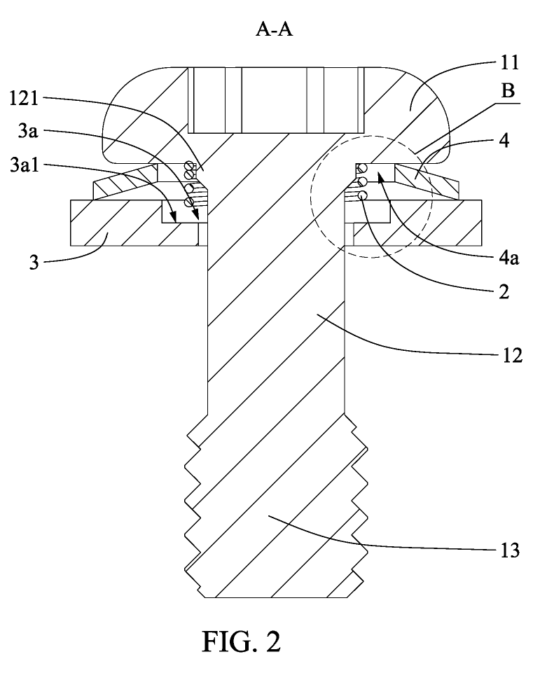

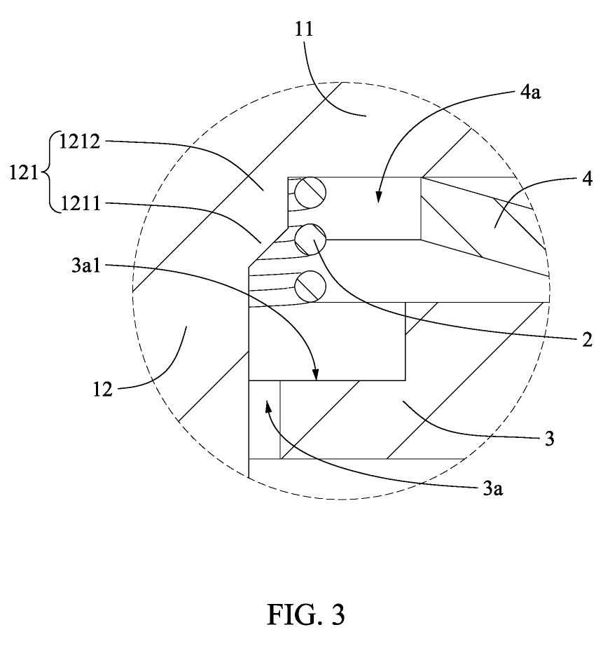

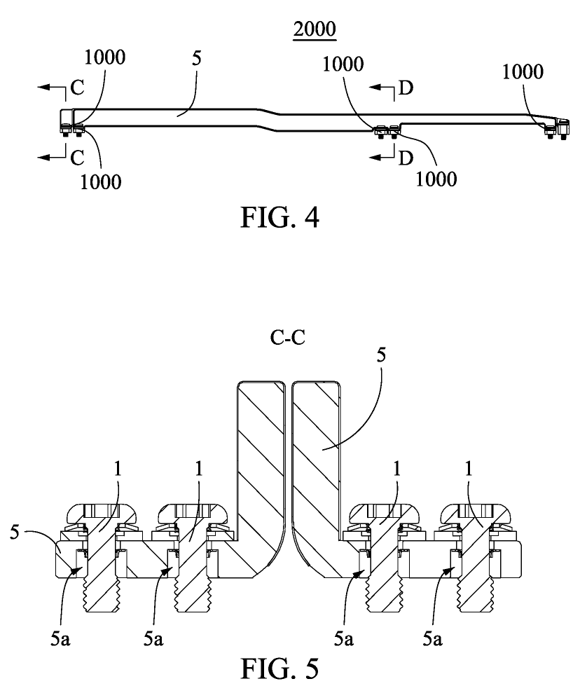

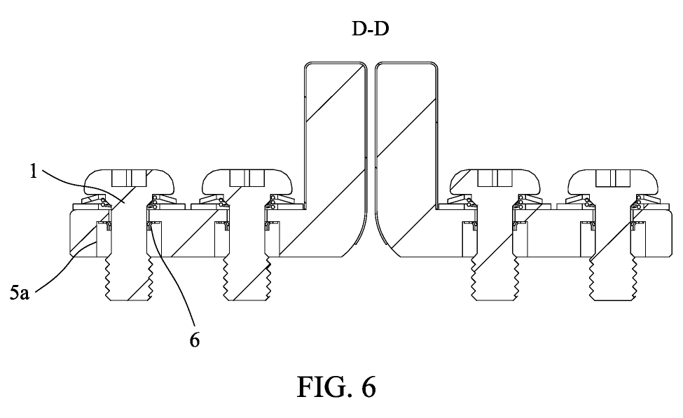

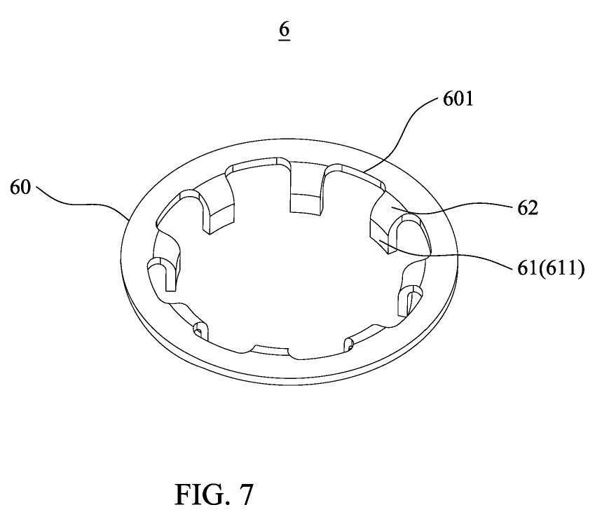

In order to solve the above problems, the present disclosure provides a screw structure 1000. FIG. 1, FIG. 2, FIG. 3, FIG. 4, FIG. 5, FIG. 6, and FIG. 7 are schematic structural diagrams of examples of the present disclosure.

Referring to FIG. 1, FIG. 2, and FIG. 3, the present disclosure provides the screw structure 1000 including a screw 1, a first elastic part 2, and a base 3. The screw 1 includes a screw head 11, a screw rod portion 12, and a thread portion 13 connected in sequence. The first elastic part 2 is disposed around the screw rod portion 12 and an end of the first elastic part 2 abuts against the screw head 11. The base 3 has a central hole 3a. The screw rod portion 12 passes through the central hole 3a and abuts against an end of the first elastic part 2 away from the screw head 11. An inner diameter of the central hole 3a is smaller than an inner diameter of the first elastic part 2, and the inner diameter of the central hole 3a is smaller than a maximum outer diameter of the thread portion 13.

The screw 1 including the screw head 11, the screw rod portion 12, and the thread portion 13 connected in sequence means that the screw 1 is consisting of three continuous portions. The screw head 11 is used to apply a rotational force. The screw rod portion 12 is used to limit the first elastic part 2. The thread portion 13 is used to screw with an external structure. Specifically, the screw 1 can be formed by one-piece molding or by assembling of separate parts to ensure the structure stability and the assembly convenience. The first elastic part 2 is disposed around the screw rod portion 12, and an end of the first elastic part 2 abuts against the screw head 11. That means that the first elastic part 2 is mounted around the screw rod portion 12 with one end contacting the screw head 11. The first elastic part 2 can be specifically implemented as a spring or an elastic rubber ring, which provides a preload force through elastic deformation to prevent the screw 1 from loosening. The base 3 is formed with a central hole 3a. The screw rod portion 12 extends through the central hole 3a, and abuts against an end of the first elastic part 2 that is away from the screw head 11. This means that the base 3 is disposed around the screw rod portion 12 through the central hole 3a and abuts against another end of the first elastic part 2, such that the base 3 allows the elastic element to be compressed and deformed to absorb vibrations, while simultaneously limiting its displacement. An inner diameter of the central hole 3a is smaller than an inner diameter of the first elastic part 2 and is smaller than a maximum outer diameter of the thread portion 13. This means that the central hole 3a of the base 3 is designed to be smaller than the diameter of the first elastic part 2 and the thread portion 13, which can be specifically implemented by precision machining, such that the base 3 is forced to be installed before the thread portion 13 is fastened to prevent omission and to form a mechanical limit through the difference in size simultaneously. It is worth mentioning that the base 3 is integrally made of a metal material, and the particular material of the base 3 may be the same as that used for the screw 1.

In the technical concept of the present disclosure, by designing the dimensions of the central hole 3a of the base 3, the first elastic part 2, and the thread portion 13, the assembly sequence is forcibly limited to prevent the omission of the base 3 or displacement of the first elastic part 2. Meanwhile, a buffering structure is formed by the abutting relationship of the first elastic part 2 and the base 3 to enhance the vibration resistance of the screw structure 1000. By designing the inner diameter of the central hole 3a of the base 3 to be smaller than the inner diameter of the first elastic part 2 and the maximum diameter of the thread portion 13, the self- positioning of the assembly may be achieved to enhance the assembly reliability of the screw structure 1000 and reduce human error. In highly reliable connection applications such as servers, the screw structure 1000 of the present disclosure may reduce the loosening risk of connection due to improper assembly and enhance the stability of long-term operation of apparatuses.

It should be noted that when the screw structure 1000 of the present disclosure is produced, it is necessary to first finish the pre-assembly of each component and then the thread portion 13 is manufactured by thread rolling process to ensure that each component may not fall out after installation.

Referring to FIG. 2 and FIG. 3, in the example of the present disclosure, the central hole 3a is formed with a stepped surface 3a1 facing the screw head 11. An end of the first elastic part 2 away from the screw head 11 abuts against the stepped surface 3a1.

During assembly, the screw rod portion 12 sequentially passes through the first elastic part 2 and the central hole 3a of the base 3. When the thread portion 13 is screwed in the connection part, the first elastic part 2 is limited between the screw head 11 and the stepped surface 3a1. The stepped surface 3a1 is a rigid support surface to limit radial displacement of the first elastic part 2. The lateral component force generated by the first elastic part 2 during compression deformation is stopped by a hole wall of the central hole 3a on the outer edge of the stepped surface 3a1 to limit the lateral displacement of the first elastic part 2.

Through this kind of structural design, the first elastic part 2 can be stably positioned between the base 3 and the screw head 11 and is not easy to displace or fall out. It can effectively prevent the displacement of the first elastic part 2 during installation or utilization to enhance the stability of the whole screw structure 1000.

Referring to FIG. 2 and FIG. 3, in an example of the present disclosure, a protruding ring 121 is formed on an end of the screw rod portion 12 adjacent to the screw head 11. An end of the first elastic part 2 away from the thread portion 13 is engaged and sleeved on an outer wall of the protruding ring 121.

Specifically, the protruding ring 121 can be manufactured in one-piece with the screw rod portion 12 and be also fixed on the screw rod portion 12 by connection in welding or screwing.

The protruding ring 121 provides a stable locking point for the first elastic part 2 to enhance the stability of the whole screw structure 1000. This can simplify the assembly process and enhance the reliability of the screw structure 1000 in long-term utilization. Since the first elastic part 2 is fixedly secured in a default position, the screw structure 1000 can absorb the vibration and the impact to extend the utilization life of the connection of the screw 1.

Furthermore, referring to FIG. 3, in an example of the present disclosure, the protruding ring 121 includes an inserting section 1211 and an engaging section 1212. The inserting section 1211 is located on an end of the engaging section 1212 away from the screw head 11. The inserting section 1211 gradually narrows along a direction from an end of the inserting section 1211 adjacent to the screw head 11 to an end of the inserting section 1211 away from the screw head 11.

The inserting section 1211 and the engaging section 1212 are formed a continuous structure. The diameter of the inserting section 1211 gradually decreases from the end adjacent to the screw head 11 to the end away from the screw head 11. When the cone surface of the inserting section 1211 contacts the inner wall of the first elastic part 2, it may guide the first elastic part 2 to slide from the inserting section 1211 to the engaging section 1212.

Specifically, when the first elastic part 2 is pushed to the protruding ring 121 during assembly, the inner wall of the first elastic part 2 first contacts the cone outer surface of the inserting section 1211. Since the diameter of the inserting section 1211 is gradually increased, the first elastic part 2 can smoothly slide into the inserting section 1211 in an axial movement. The guiding through inserting section 1211 simplifies the position operation of the first elastic part 2, and simultaneously ensures the stability of by stationary diameter of the engaging section 1212 to prevent the first elastic part 2 from falling out or displacement due to installation deviation. During assembly, an operator only needs to align the first elastic part 2 to the inserting section 1211 and slightly pushes it to finish the installation. It is not necessary to strenuously align or forcibly press such that it may enhance the efficiency of assembly and reduce ricks of wrong operation.

Referring to FIG. 1 and FIG. 2, the screw structure 1000 further includes a second elastic part 4. The second elastic part 4 is disposed around the screw rod portion 12 and is located between the screw head 11 and the base 3.

Specifically, when the screw 1 passes through the through hole 5a of the busbar 5 and is fastened to a bracket, the second elastic part 4 is compressed between the screw head 11 and the base 3, and is formed a bidirectional elastic support with the first elastic part 2. An outer edge of the second elastic part 4 is fit to a surface of the base 3 during compression. By increasing contact area to distribute stress, the base 3 is prevented from compression deformation by the screw head 11 such that it may enhance the stability of the screw structure 1000.

Specifically, when the screw 1 passes through the through hole 5a of the busbar 5 and is fastened to a bracket, the second elastic part 4 is compressed between the screw head 11 and the base 3, and is formed a bidirectional elastic support with the first elastic part 2. An outer edge of the second elastic part 4 is fit to a surface of the base 3 during compression. By increasing contact area to distribute stress, the base 3 is prevented from compression deformation by the screw head 11 such that it may enhance the stability of the screw structure 1000.

Referring to FIG. 2 and FIG. 3, in an example of the present disclosure, the second elastic part 4 has a through hole 4a. The screw rod portion 12 passes through the through hole 4a. An inner diameter of the through hole 4a is smaller than a maximum outer diameter of the screw head 11. A diameter of the second elastic part 4 is larger than the inner diameter of the central hole 3a.

By adding the second elastic part 4 between the screw head 11 and the base 3 and designing the diameter of the second elastic part 4 larger than the inner diameter of the central hole 3a, the problem of the omission of the base 3 can be effectively prevented. Meanwhile, the situation of reversed disc springs may be also prevented because the inner diameter of the through hole 4a of the second elastic part 4 is smaller than the maximum outer diameter of the screw head 11. The design can significantly reduce the possibility of human error and enhance the reliability of the installation of the screw structure 1000.

Referring to FIG. 2, in an example of the present disclosure, the diameter of the second elastic part 4 is smaller than the diameter of the base 3.

Since the diameter of the second elastic part 4 is smaller than the diameter of the base 3, it can effectively prevent the second elastic part 4 from directly contacting the busbar 5 during the installation. It can prevent the surface of the busbar 5 from being scratched or abrasion by the second elastic part 4 to protect the integrality of the busbar 5. The base 3 completely covers the second elastic part 4, which may act as a cushion and protect it, to reduce the friction between the screw structure 1000 and the busbar 5 and to enhance the stability of the connection. The second elastic part 4 is limited within a relative enclosed space by this design, making it less easily to displacement or fall out, and to further enhance the reliability of the screw structure 1000. Since the second elastic part 4 is completely covered by the base 3, even if the second elastic part 4 is reversed during installation, the second elastic part 4 does not directly affect and contact the busbar 5. It thereby reduces the impact of human error on the connection quality.

To be understood, the first elastic part 2 can be a silicon block, a spring, and also other elastic objects. In an example of the present disclosure, the first elastic part 2 is a spring.

The first elastic part 2 is a cylinder helical spring. The spring is disposed around the outer surface of the screw rod portion 12, and two end of the spring are separately formed planar contact with the end surface of the screw head 11 and the stepped surface 3a1 of the base 3. The spring is made of a cold drawn steel wire wound and the wire cross section is circle. The free length of the spring is larger than the axial length of the screw rod portion 12 between the screw head 11 and the base 3. When the screw 1 is screwed within the connector 2000, the spring is compressed between the screw head 11 and the stepped 3a1 to generate an elastic recovery force perpendicular to the axial direction of the screw rod portion 12.

By utilizing the symmetrical structure of cylinder helical springs, the directional requirements for the installation of the elastic parts are eliminated to avoid assembly errors caused by direction misjudgment. The linear elastic properties of the spring can generate a uniform preload to ensure that the thread portion 13 and the connector 2000 always maintain a stable contact pressure.

To be understood, the second elastic part 4 can be a disc silicon block and also a disc spring. In an example of the present disclosure, the second elastic part 4 is a disc spring.

By using the second elastic part 4 which has a direction identification feature, the asymmetrical geometry can effectively avoid the incorrect direction of the assembly. The linear elastic properties of the spring can generate a uniform preload to prevent the base 3 from extrusion deformation by screw head 11.

The present disclosure further provides a connector 2000. The connector 2000 includes a busbar 5 and a screw structure 1000, which is described in the foregoing examples. Since the connector 2000 adopts all the technical solutions of the foregoing examples, it at least possesses all the advantageous effects brought by the technical solutions of the foregoing examples, and therefore will not be described herein again.

Referring to FIG. 4 and FIG. 5, in an example of the present disclosure, the base 3 is disposed on the busbar 5. The busbar 5 has a through hole 5a. The screw rod portion 12 and the thread portion 13 pass through the through hole 5a. By connecting the busbar 5 is connected to the screw structure 1000 in this manner, the risk of the omission of components of the independent base 3 during assembly can be effectively prevented.

Referring to FIG. 6 and FIG. 7, in an example of the present disclosure, the connector 2000 further includes a circlip 6 to limit the screw 1. The circlip 6 includes a circlip ring 60 and a limiting part 61. The circlip ring 60 has a notch 601 to be disposed around the screw 1. The limiting part 61 is disposed at an edge of the notch 601. The limiting part 61 is perpendicularly disposed at the circlip ring 60. A surface of the limiting part 2 is face to an outer wall of the screw rod portion 12 in a perpendicular direction. The limiting part 61 is used to limit the screw rod portion 12.

In the example of the present disclosure, by disposing the circlip 6 between the screw 1 and the through hole 5a, the screw 1 can be prevented from falling out the through hole 5a to enhance the safety and the convenience of the busbar 5 transportation. The limiting part 61 is perpendicularly disposed at the circlip ring 1, which can allow the circlip 6 being inserted between the screw 1 and the hole wall of the through hole 5a. By perpendicularly disposing the limiting part 61 and the circlip ring 60, the circlip 6 can be allowed to dispose between the screw 1 and the through hole 5a. The perpendicularly disposed limiting part 61 can prevent the screw 1 from being turned out the through hole 5a to enhance the safety and the convenience of the busbar 5 transportation.

The circlip 6 of the present disclosure includes the circlip ring 60 and the limiting part 61, which is perpendicularly disposed to the circlip ring 60. The circlip ring 60 has the notch 601. The limiting part 61 is disposed around the edge of the notch 601, and is positioned relative to the circlip ring 60 such that the limiting part 61 is disposed perpendicular to the circlip ring 60. After the screw 1 is inserted the through hole 5a of the busbar 5, the circlip 6 can sleeve from the bottom of the screw 1 to the screw rod portion 12 without thread of the screw 1. The perpendicular surface of the limiting part 61 is toward the outer wall of the screw rod portion 12 to limit the screw 1. The limiting part 61 is disposed perpendicular to the circlip ring 60 so as to occupy less space in the radial direction and to be easily installed in the narrow gap between the screw 1 and the through hole 5a.

In some examples of the present disclosure, an inner diameter of the limiting part 61 is smaller than an outer diameter of the thread portion 13 and larger than an outer diameter of the screw rod portion 12.

In the example of the present disclosure, since the value of the inner diameter of the limiting part 61 is between the values of the outer diameter of the thread portion 13 and the outer diameter of the screw rod portion 12, the circlip 6 dose not shift or fall out on the screw 1 after installation to enhance the safety of the transportation.

In some examples of the present disclosure, a length of the limiting part 61 is larger than a pitch of the thread portion 13.

In the example, the length of the limiting part 61 is larger than a pitch of the thread portion 13, that is, larger than the distance between two adjacent threads of the thread portion 13. This can prevent the limiting part 61 of the circlip 6 from rotating and falling from the thread portion 13 of the screw 1 to enhance safety during transportation.

In some examples of the present disclosure, a connection between the limiting part 61 and the circlip ring 60 has a guiding portion 62, and a diameter of the guiding portion 62 gradually narrows along a direction from the circlip ring 60 to the limiting part 61.

In the example, the connection between the limiting part 61 and the circlip ring 60 has the guiding portion 62. The shape of the cross-section of the guiding portion 62 is circular arc. The diameter of the guiding portion 62 gradually narrows along the circlip ring 60 to the limiting part 61. When the circlip 6 is installed on the screw 1, the installation process becomes more smoothly under the guidance of the guiding portion 62.

In some examples of the present disclosure, the circlip ring 60, the guiding portion 62, and the limiting part 61 are made in one-piece.

In the example, the circlip ring 60, the guiding portion 62, and the limiting part 61 are made in one-piece, and the one-piece design can reduce the installation steps during manufacture to reduce the production costs and time. In addition, since the circlip ring 60, the guiding portion 62, and the limiting part 61 are made in one-piece, the stability and the durability of whole structure of the circlip 6 can be enhanced to reduce the risks of failures caused by improper connection.

In some examples of the present disclosure, the limiting part 61 includes plural spring sheets 611. The spring sheets 611 are disposed in apart along the edge of the notch 601.

In the example, disposing the spring sheets 611 in the limiting part 61 can distribute the force to enhance the whole strength and the durability of the circlip 6 and to reduce the risk of structural failure caused by fatigue or damage of a single spring sheet 611. The spring sheets 611 are spaced apart from one another, allowing the installation and the adjustment at different positions so as to accommodate the screw 1 with different diameters, thereby improving the adaptability and the flexibility of the circlip 6.

In some examples of the present disclosure, the number of the spring sheets 611 is a plurality. A guiding portion 62 is disposed between each spring sheet 611 and the circlip ring 60.

In the example, each spring sheet 611 connects to the circlip ring 60 with a guiding portion 62. When the circlip 6 is installed onto the screw 1, each spring sheet 611 can smoothly pass through the screw 1 under the guidance of the guiding portion 62 that makes the installation smoother. During installation, each spring sheet 611 can slightly deform relative to the surface of the circlip ring 60 around the guiding portion 62, allowing the circlip ring 60 to pass through the thread portion 13 having a larger outer diameter. After passing through, the spring sheet 611 can return to its original shape to abut against the outer wall of the screw rod portion 12. Once the circlip 6 is installed in place, it does not slide or fall out from the screw 1 thereby improving the safety during transportation.

In some examples of the present disclosure, the spring sheets are disposed in apart along the edge of the axial direction of the circlip ring 60.

In the example, the spring sheets 611 are axially and evenly distributed along the circlip ring 60. In the example, the spring sheets 611 are axially and evenly distributed along the circlip ring 60, which can evenly distribute and spread the force to reduce the risk of structural failure caused by fatigue or damage of a single spring sheet 611.

In some examples of the present disclosure, the circlip 6 is made of metal materials.

In the example, the circlip 6 is made of a metal material, such as aluminum alloy or stainless steel, which has certain elastic deformability, high strength and durability, and excellent corrosion resistance.

The above descriptions are merely exemplary embodiments of the present disclosure and are not intended to limit the scope of the present disclosure. Any equivalent structural modifications made by using the specification and the accompanying drawings of the present disclosure within the inventive concept of the present disclosure , or directly or indirectly applied in other relative technical fields all fall within the protection scope of the present disclosure.

What is claimed is:

1. A screw structure, comprising:
a screw comprising a screw head, a screw rod portion, and a thread portion connected in sequence;
a first elastic part disposed around the screw rod portion wherein an end of the first elastic part abuts against the screw head; and
a base having a central hole wherein the screw rod portion passes through the central hole and abuts against an end of the first elastic part away from the screw head;
wherein an inner diameter of the central hole is smaller than an inner diameter of the first elastic part, and the inner diameter of the central hole is smaller than a maximum outer diameter of the thread portion.

2. The screw structure of claim 1, wherein the central hole is formed with a stepped surface facing the screw head, and an end of the first elastic part away from the screw head abuts against the stepped surface.

3. The screw structure of claim 2, wherein the screw rod portion has a protruding ring protruding from an end of the screw rod portion adjacent to the screw head, wherein an end of the first elastic part away from the thread portion is engaged and sleeved on an outer wall of the protruding ring.

4. The screw structure of claim 3, wherein the protruding ring comprises a inserting section and an engaging section connected to each other, the inserting section is located on an end of the engaging section away from the screw head, and the inserting section gradually narrows along a direction from an end of the inserting section adjacent to the screw head to an end of the inserting section away from the screw head.

5. The screw structure of claim 1, wherein the screw structure further comprises a second elastic part, and the second elastic part is disposed around the screw rod portion and located between the screw head and the base.

6. The screw structure of claim 5, wherein the second elastic part has a through hole and the screw rod portion passes through the through hole, an inner diameter of the through hole is smaller than a maximum outer diameter of the screw head, and a diameter of the second elastic part is greater than the inner diameter of the central hole.

7. The screw structure of claim 6, wherein the diameter of the second elastic part is smaller than a diameter of the base.

8. The screw structure of claim 1, wherein the first elastic part is a spring.

9. The screw structure of claim 5, wherein the second elastic part is a disc spring.

10. A connector, wherein the connector comprises a busbar and the screw structure of claim 1, the base is disposed on the busbar, the busbar is formed with a through hole, and the screw rod portion and the thread portion pass through the through hole.

11. The connector of claim 10, further comprising a circlip to for limiting the screw, wherein the circlip comprises:
a circlip ring having a notch for the screw to pass through; and
a limiting part disposed on an edge of the notch and perpendicular to the circlip ring.

12. The connector of claim 11, wherein a surface of the limiting part in a perpendicular direction faces an outer wall of the screw rod portion and the limiting part is for limiting the thread portion.

13. The connector of claim 11, wherein an inner diameter of the limiting part is smaller than an outer diameter of the thread portion and greater than an outer diameter of the screw rod portion.

14. The connector of claim 13, wherein a length of the limiting part is greater than a pitch of the thread portion.

15. The connector of claim 11, wherein a connection between the limiting part and the circlip ring is provided with a guiding portion and a diameter of the guiding portion gradually narrows along a direction from the circlip ring to the limiting part.

16. The connector of claim 15, wherein the limiting part comprises a plurality of spring sheets, and the spring sheets are spaced apart and disposed on the edge of the notch.
